(19) United States
(12) Patent Application Publication
(10) Pub. No.: US 2009/0006160 A1
(43) Pub. Date: Jan. 1, 2009

(54) System for Assigning Personnel to Tasks in Which the Personnel Have Different Priorities Among Themselves

(75) Inventor: Christian Marc Boegner, La Quinta, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: CREWING SOLUTIONS LLC, Reston, VA (US)

(21) Appl. No.: 11/577,406

(22) PCT Filed: Oct. 24, 2005
(86) PCT No.: PCT/US2005/038299

§ 371 Date: Aug. 20, 2008

Related U.S. Application Data
(60) Provisional application No. 60/622,123, filed on Oct. 25, 2004.

(51) Int. Cl. G06Q 10/00

(52) U.S. Cl. 705/8

(57) ABSTRACT

A method and system for airline crewmembers to interactively query, bid, and receive a work schedule via a network is provided. Each crewmember is able to request which trips to fly and which days off are desired. Trips are awarded to individuals based on their seniority, preferences, availability and the legality to fly the trip while satisfying company constraints. Such constraints include minimum and maximum hours flown, priorities for more senior crewmembers, and airline restrictions. The resulting schedule is tentatively assigned to the crewmember, and as each crewmembers enters preferences, the schedules of other crewmembers are changed appropriately.

### CROSS-REFERENCE TO RELATED APPLICATION

This application claims priority from U.S. Provisional Patent Application Ser. No. 60/622,123, entitled “Method and System for Placing a Bid and Receiving the Results of that Bid Via a Communications Network,” filed Oct. 25, 2004.

### BACKGROUND OF THE INVENTION

This invention relates to a computerized method and the system for assigning individuals to various duties. In particular, the invention relates to the assignment of crew members for aircraft flights in which the members have different seniorities and preferences, and in which various regulations and constraints for crew member assignment are followed. Furthermore, the invention relates to a technique for placing a bid for particular job assignments, and receiving the results of that bid over a network, typically the Internet.

In many industries, duties (jobs) are submitted by a company to its workers for bidding. Such scheduling is found where a company defines an inventory of jobs that need to be done during a specified period of time and allows its workers to pick and choose the jobs for which each is qualified over a period of time, referred to herein as the ‘bidding period.’ Each worker is able to give a preference to the job he or she prefers over another and submits a ‘bid’ to the company as to preferences in an agreed to form. When the bidding periods ends and all of the bid have been collected, all the jobs are awarded in a specified order, for example based on seniority, to all the workers. In this circumstance the preference of the ‘senior’ worker is honored before that of the junior worker. At the conclusion of the award process, all the jobs are awarded within stipulations such as company, legal, or union rules. Throughout the process, except for the worker who is number one in the ordering, a given award is highly dependent on previous awards.

The Internet comprises a vast number of computers and computer networks that are inter-connected though communication links. The interconnected computers exchange information using various services, such as electronic mail, Gopher, and the World Wide Web (WWW). The WWW service allows a server computer system (i.e., Web server or Web site) to send graphical Web pages of information to a remote client computer system. The remote client computer system can then display the Web pages. Each resource (e.g., computer or Web page) or the WWW is uniquely identifiable by a Uniform Resource Locator (URL). To view a specific Web page, a client computer system specifies the URL for that Web page in a request, e.g. a HyperText Transfer Protocol (HTTP) request. The request is forwarded to the Web server that supports that Web page. When that Web server receives the request, it sends that Web page to the client computer system. When the client computer system receives that Web page, it typically displays the Web page using a browser. A browser is a special-purpose application program that effects the requesting of Web pages and the displaying of Web pages.

Web pages are typically defined using Hyper-Text Markup Language (HTML). HTML provides a standard set of tags that define how a Web page is to be displayed. When a user indicates to the browser to display a Web page, the browser sends a request to the server computer system to transfer to the client computer system an HTML document that defines the Web page. When the requested HTML is received by the client computer system, the browser displays the Web page as define by the HTML document. The HTML document contains various tags that control the displaying of text, graphics, controls, and other features. The HTML document may contain URLs of other Web pages available on that server computer system or other server computer systems.

The assignment of crews to aircraft flights, and more generally, the assignment of individuals to schedules at various businesses which require many conflicting jobs with different characteristics to be performed at various times is in general a complex task, even without considering preferences, but simply efficient allocation. The introduction of ‘choices’ further compounds the problem and requires additional tasks which are the subject of the invention. For example, with respect to aircraft crews, crew members “bid” for jobs that are referred to as ‘trips’ (a series of flights over one or more day starting and ending at the crew member home base). Such trips are more or less desirable depending on the time at which they operate, where they go, what they pay etc., It is therefore of importance to the crew member that he has knowledge of what kind of trips are available to him at his rank, which in this case is his or her seniority level.

In most airlines there is a prescribed order in which the workforce is assigned to the jobs that need to be performed, whether it is in order of seniority or otherwise. In a seniority based system, a given person will only be assigned after others more ‘senior’ to him have been assigned. Each crewmember gains experience in what trips are likely available to him and, based on this information, that crewmember is able to plan his activities, albeit with not as much certainty as he or she may desire. In today's allocation systems based on preferences, the ‘bidders’ are bidding without direct information of what others have bid, and unaware of the availability of the jobs available at their seniority level. The resulting assignments are given via a batch process and often do not meet the expectations of the workforce.

With such systems, crewmembers are “served” in seniority order. That is, a crewmember will not be awarded trips and days off until all other crewmembers senior to him have been assigned trips and days off. Crewmembers' major objections to such systems include being forced to bid without knowing the availability of trip choices and availability of days off at their respective seniority level, and whether mandatory workdays are required or not. If the crewmember had this knowledge, he would be able to plan his activities with much greater degree of certitude and accuracy.

Presently available commercial systems for allocating flights among crew members include systems provided by Carmen Systems, Navtech, AOS, AD-OPT Technologies, AIMS, AOS, Forte Solutions, and Jeppesen. Each of these systems process the crewmembers' bids in a batch operation after the bid close date and return only the final award to the crewmember. There is no opportunity for interactivity in these systems other than bid entry (recording the bid) and/or getting global statistics as to availability and demand. In particular, there is no capability for the crewmember to interact with the server system at his or her specific seniority level to query trip pairing or days off inventories, identify and select bid preferences and, perhaps most importantly, have the server system return a proposed schedule based on the bid preferences prior to the closing date.

It would therefore be useful for a worker at given rank to gain knowledge of the demands of workers of higher rank and to be in a position to modify is preferences in function of the demands made by the senior workers.

### BRIEF SUMMARY OF THE INVENTION

Preferential bidding is a method of allocating predefined jobs to arrive at schedules for employees over an arbitrary time period and where employees are entitled to state their preferences as to different possible choices and have these preferences reflected in their schedules. Although the preferred embodiment herein is described in the context of the airline industry and the scheduling of flight crews, the invention extends to any similar environment where jobs are to be awarded over a time period to the employees according to their stated preferences. In the present embodiment a job is a trip (a series of flights over one or more days starting at a home base and returning to that base) and the employees are flight crews necessary for the operation of these trips. According to the system of this invention, each crewmember is able to request which trips to fly and which days off are desired. Trips are awarded to individuals based on their seniority, preferences, availability and the legality to fly the trip while satisfying company constraints such as minimum and maximum hours flown in a bid period (typically a month), priorities for more senior crewmembers, and the like. The resulting schedule is referred to as a line of time, a bid award, or often, just a “line.”

The invention includes software programs accessed via the Internet or a network, using the notion of a client (the crewmember) communicating with a server. The information submitted is processed by the server and returned to the user for evaluation. The user is informed of the current availability of choices and the manner in which they can be combined to satisfy the crewmember's request. The software consists of two main components: a graphical user interface through which the user interacts with the system and a manpower allocation system that performs the necessary computations to distribute the tasks to the workforce and insure complete coverage of all the trips that have be planned for the bid period whether desirable or not.

The invention provides a method and system for bidding for, and receiving, an individual schedule for that crewmember. The system provides a means of supplying feedback in response to the different bids that a crewmember may submit. This feedback and evaluation can be repeated whenever a crewmember desires, and is based on the most recent set of bid submissions from other bidders available at the time of that computer run. From a crewmember's point of view, the process has aspects similar to an auction, in that subsequently submitted bids by higher-seniority crewmembers may impact the bid awards previously tentatively assigned by the bid award process. The junior crewmember can than revise and enhance his bids to reflect the latest set of trips and days off available to him at his seniority level, thereby maximizing his satisfaction with awarded trips. The availability and bid assignment predictions are based on the latest available bids from all crewmembers, and feedback of the effect of a present bid, all contribute to the ability for each crewmember to devise the best bids for the schedule closest to the one that crewmember desires.

Preferably, the bidding process is iterative from the specific to the generic, i.e., a specific trip on a given date to a broader category of trips. The crewmember bids by first searching for trips that he would like to fly. This search is made by clicking on various preference items (i.e., trip pairing number, flight number, day of week, departure time, etc.). The system returns to the crewmember the list of available trips matching the criteria submitted. If the crewmember does not add trips from this listing to his bid, the displayed trips are returned to the pool of available trips. On the other hand if he chooses to make this selection part of his bid he clicks on the ‘add to bid’ icon, and the system builds a line of time based on all of the selections made to that point, including this latest one. In one implementation, the crewmember builds his bid through a series of independent selections, and at every step, the system returns to him a line of time based on his bid from which the crew member is able to judge the completeness and robustness of his bid (see backup line).

### BRIEF DESCRIPTION OF THE DRAWINGS

FIG. 1 is a system block diagram of the system illustrating the basic data flow among the client, the server, and the airline;

FIG. 2 is a block diagram of the basic operation of the system;

FIG. 3 is a diagram of the preferential bidding system engine;

FIG. 4 is a diagram of the line builder process;

FIG. 4a is a diagram of the “evaluate” process of FIG. 4;

FIG. 4b is a diagram of the “recombine” process of FIG. 4;

FIG. 5 is a flow chart of the bidding process;

FIGS. 5a, 5b, and 5c are expanded diagrams of portions of FIG. 5;

FIG. 6 is a further flow chart of the bidding process;

FIG. 7 is a flow chart relating to bidding for days off;

FIG. 8 is a diagram illustrating display of the crewmember's award;

FIG. 9 is a diagram illustrating a trip search process;

FIG. 10 is a diagram illustrating a search results display; and

FIG. 11 is a diagram illustrating bidding trips.

### DETAILED DESCRIPTION OF THE INVENTION

The system solves in a manner determined by the particular preferences and constraints, manpower allocation problems where workers are allowed to choose among an inventory of tasks and schedule those that they would prefer to do over other tasks. The invention produces a planned schedule of activity, respecting as much as possible the individual preferences of the workers within an agreed set of rules and constraints. Such constraints typically include federal or company work limits, required time off, and other contractual and/or legal restrictions such as maximum hours per week. Each crewmember is thus able to devise better bids for their individual schedule to achieve the most attractive feasible bid award available.

In the preferred embodiment, the system of this invention is applied to scheduling of airline crews. It will be appreciated, however, that it is also applicable to many other circumstances, such as other transportation industries, and more generally to any business having a workforce assigned to specific predefined tasks to be done at specific times. For example, the system can be used to assign nurses in hospitals, workers in manufacturing operations, the ground staff at an airport, etc.

The system of this invention provides an interactive web-based computer application that enables individuals, for example, airline crewmembers, to evaluate the efficacy of bids for particular trips at different times, and as often as desired during the bid submission period. The bid award computer process runs essentially continuously—each iteration using the latest cumulative set of bids submitted all crewmembers who have bid as of that time. While the latest repetition is running, any crewmember interacting with the invention is presented his bid award results based on the results of the previous repetition. In this manner, each crewmember is able to assess and determine the set of bids to specify to obtain the set of available trips desired. The results are ranked and determined by the evaluation criteria for that individual, and reflect the latest best estimate of the allocation of all trips to all crew members as of the time of the report.

For each scheduling period, a bid deadline is established, usually a period measured in days before the beginning of the scheduled period (typically a month). When the bid submission period is over, no further bids are accepted. The set of bids received prior to the deadline are declared to be the final set of crewmember bids. Then the bid award process is run one last time, using the final set of bids, and the results become final. On that basis, the crew is assigned to the various trips that need to be covered in the scheduling period.

The bids are entered by crewmembers through the Internet, or an Intranet web-based program. This enables displaying and browsing through the available trips, and allows ranking them in a variety of user-specified ways. It also provides different methods of bidding for desirable trips, periods of days off, and patterns of work and rest. At any time the crewmember can submit a bid and receive back a nominative awarded set of trips based on the latest set of bids received from all other crewmembers. Depending upon the particular computer system used, the number of trips, the number of crewmembers, and other factors, the response time can be sufficiently short to allow crewmembers to try different bids at different times, thereby obtaining a preferred schedule.

Because the system preferably runs continuously on the information gathered, as the time of final award approaches, the crewmember sees the bid evolving either in the manner desired or otherwise. The crewmember is directly notified that the choices made earlier are still available or have been changed, as a result of the bids of others. Further, the crewmember is informed of the certainty, or lack thereof, of his choices, as bids senior to him are gathered and processed. Preferably, upon login, a notification of what percent of the bidders senior to him have submitted bids is given so as to give an appreciation of the certainty of the choices made.

During the period between bid posting and bid closing, there can be hundreds, if not thousands, of crewmembers interacting with the system to determine their best possible schedule for the upcoming bid period. Among advantages of the invention are automated bid entry with point and click operations, online continuous processing for fast feedback on bid entry, crewmember control over trip rating, real time inventory transparency, the ability to make multiple separate bids, the choice of line build method, an on-line audit report, an iterative line building option, crew member alert notification via email, and disclosure of line building constraints

Current systems provide for only one bid per crewmember and do not have the capability of a ‘what-if’ schedule scenario. This system allows the crewmember to store multiple separate and distinct schedule scenarios in addition to the ‘standby bid’ (a bid that would be used if the crew member failed to submit a bid) at any one time. This feature allows the crewmember to explore various schedule options for the upcoming period. For example, the crewmember may have one bid calling for weekends and Mondays off with layovers in DFW, another bid that anticipates as yet an unconfirmed family trip the week of the 4^{th}, and a third bid that reflects a desire to attend a business course at the local college that meets every Tuesday, Wednesday and Friday afternoon. All of these bids evolve during the bidding process and the crewmember gains more or less certainty whether he will be able to hold one of them, or not.

The knowledge of what trips and days off are available to the bidder at his seniority level is critical for intelligent bidding. The system provides real time inventory transparency (trip/days off/reserve/mandatory days). Without knowledge of the trip and days off inventory as well as any critical periods, crewmembers of lower seniority are often assigned in a less than optimal manner. For example, when a junior crewmember bids, he might see the system is critical on the 5^{th} and 25^{th} and thus he must fly on those days; there are no more trips to LAX; the weekend of the 16^{th} is still available; and he could probably have vacation from the 26^{th} through the 30^{th} if desired. With this knowledge, the crewmember can bid more intelligently.

Although the system builds the crewmember a legal monthly schedule within acceptable minimum and maximum criterion, the crewmember has the ability to bid in steps. For example, the crewmember may bid for a specific three day trip that operates on Mondays. The system will return the crewmember with a line containing these trips plus two additional trips that he has not bid for in order to complete the crewmember's line. In reviewing his bid results, the crewmember may then decide that he wants a two day trip on the second and fourth Thursday of the month. He will add this preference to his bid and the system will return a line with the 3 day trips on Mondays and the two trips on Thursday that he requested. Framing or building the bid in this manner helps the crewmember understand the bid dynamics that are in play and thus he will better optimize his results.

As successive bid awards are completed and changes occur in a crew member's line the system will notify the affected crew member via email according to parameters set by the crew member, namely at his/her option an email message can be sent automatically in accordance with preferences such as:

Do not notify me of any changes

Notify me if a day off I had bid and that was previously honored is no longer honored

Notify me if a day off I had bid and was previously denied is now available to me

Notify me if a trip I had bid for and previously held is no longer available to me

Notify me if a trip I do not want is now present in my line (whereas it wasn't before)

Notify of any changes that occur in my line

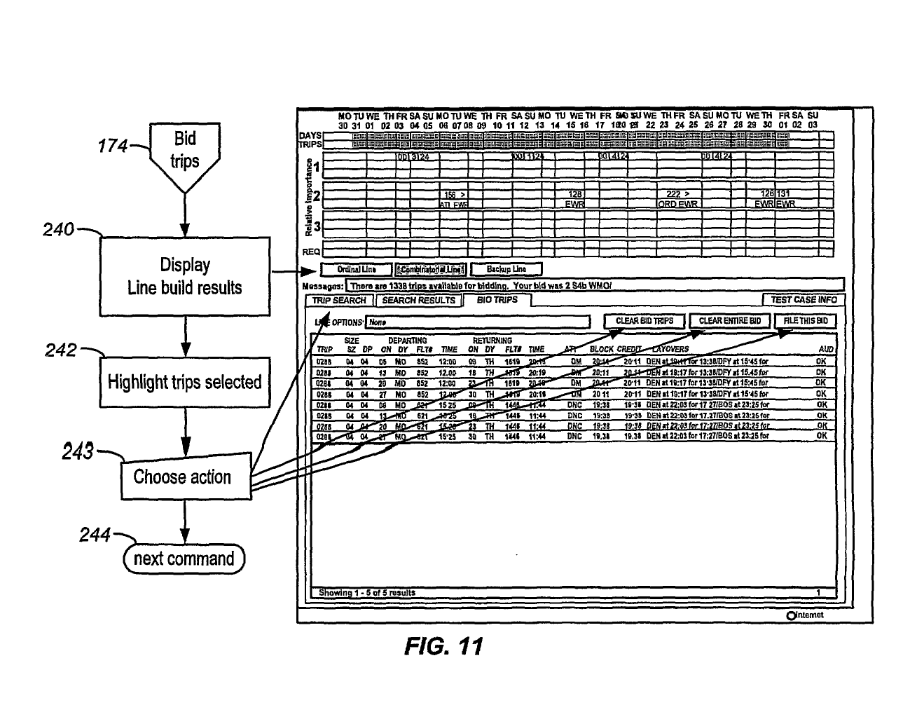

Notifications are in the form of an email messages to the crew members with an image of the awarded line as it appeared on the screen at time of biding (see FIG. 11).

The system includes three component software applications: (1) the actual bid award software process that accepts a set of crew data, crew bids, and available trips to be awarded to the crewmembers, and produces a set of bid awards that distributes the available trips among the crewmembers in such a way as to leave zero or a small number of unassigned trips, assigns the trips as requested by the crewmembers in a strict seniority order, and satisfies all regulatory, contractual, and company scheduling restrictions. (2) The second application is a web-based program that provides the interface used by the crewmembers. This application enables displaying the available trips, and ranking them in user-specified ways. It also provides different methods of bidding for desirable trips, periods of days off, and patterns of work and rest. (3) The third application is a web-server application that communicates between the bid award process and the browser application, passing messages between them and producing the html messages that instruct the web browser application what to display. The system is described in more detail next.

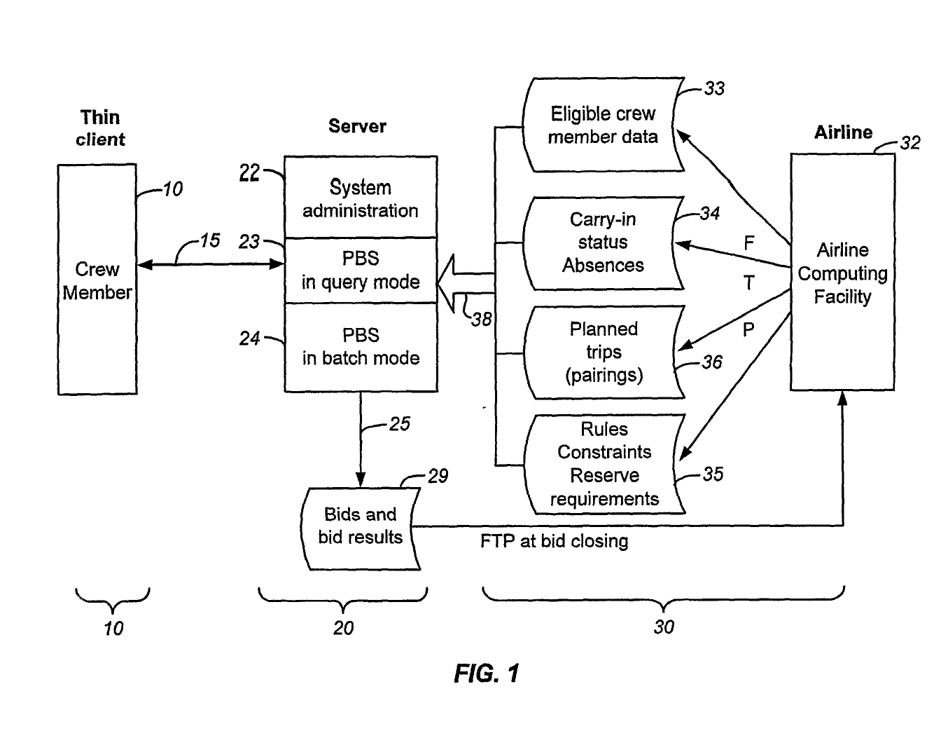

FIG. 1 is a block diagram illustrating the overall system as preferably used to implement this invention. In general the hardware system is divided into three portions: a client 10, a server 20, and an airline computing facility 30. The client 10 is a typical computer coupled to the Internet or other network, for example, a Unix or Windows-based personal computer or terminal. Client 10 interacts with the server 20 over a communications link 15. The server 20 includes a system administration portion 22, and a preferential bidding system (PBS) engine which can operate in query mode 23 and batch mode 24. The system operates essentially continuously in a “batch” mode, processing bids and updating the status of all bidders for all tasks. It also operates in a “query” mode when a crewmember is logged on, interacting with the user to accept and display bids and results, as shown below.

The server 20 is coupled via an appropriate communication link 38 to data processing facilities 30 at the airline. The data processing facilities there include the particular computing facility 32 which that airline uses. That computing facility typically provides information about crew members 33, their status 34, and information about rules, constraints, reserve requirements, etc. 35 which constrain the particular activities of the crew member. The facility also includes “carry-in” status 34 for the crew members, typically their presently assigned schedule and information about vacations or other absences. The airline computing facility 32 also has information about planned trips 36 as presently scheduled to be staffed by the crew members. The server 20 and the airline computing facility 32 work together to generate bids and bid results 29 as discussed below.

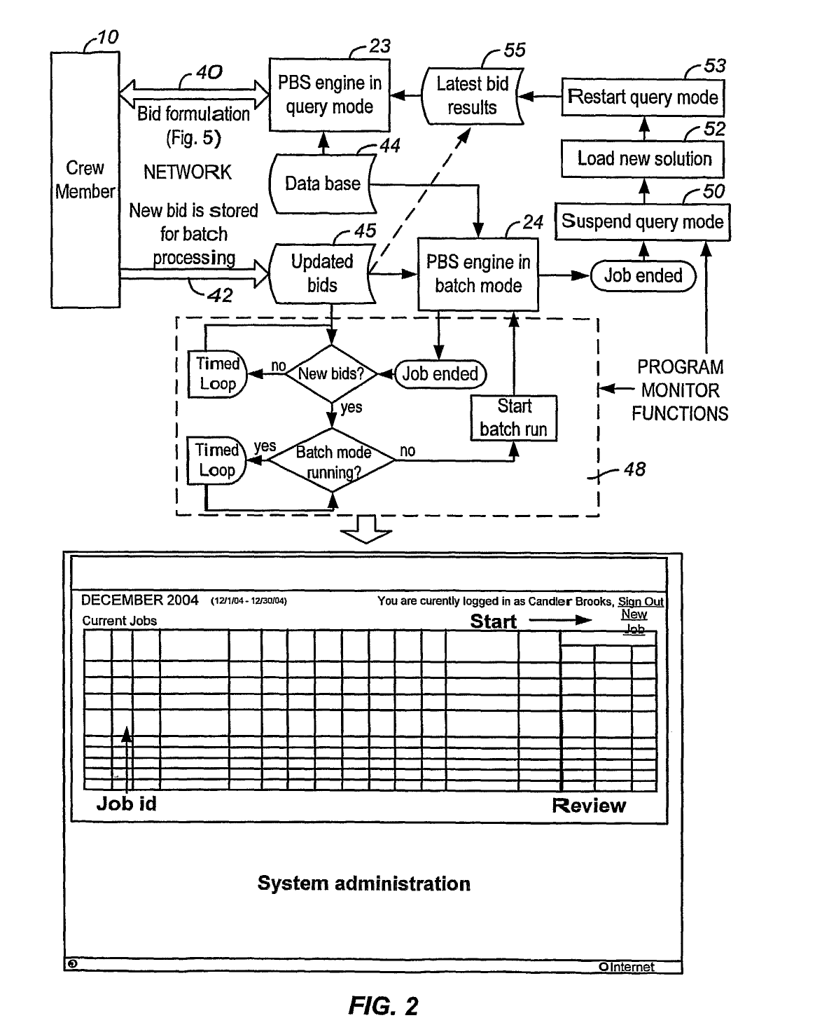

FIG. 2 illustrates the basic operational functions performed by the server 20. As shown, the crew member interacts with the system via the client 10. The information flow includes bid formulation information 40 and the presentation of new bids 42. As shown in the upper portion of FIG. 2, the bid formulation information is passed to the PBS engine in query mode. The engine operates in conjunction with information from the database 44, which includes the information from the airline computing facility 32. Upon entry of a new bid, the updated bid 45 is provided to the PBS engine operating in batch mode 24. The operation of that engine in batch mode is shown in the block 48. In this mode the system continually seeks new bids based on a timed loop. The new bids from crew members are processed by the engine in batch mode and the results provided. When the batch mode ends, the query mode is suspended 50 and new results are loaded 52 and the query mode restarted 53. Preferably, the suspension is brief, not noticeable to the on-line users). Using these latest bid results 55 the information is again displayed to the crew member.

The lower portion of FIG. 2 illustrates information made available to the system administrator. That user interface depicts the particular flights, staffing levels as of the last batch run, and other information as desired by the administrator, typically a manager at an airline who wishes to check on flight crew status.

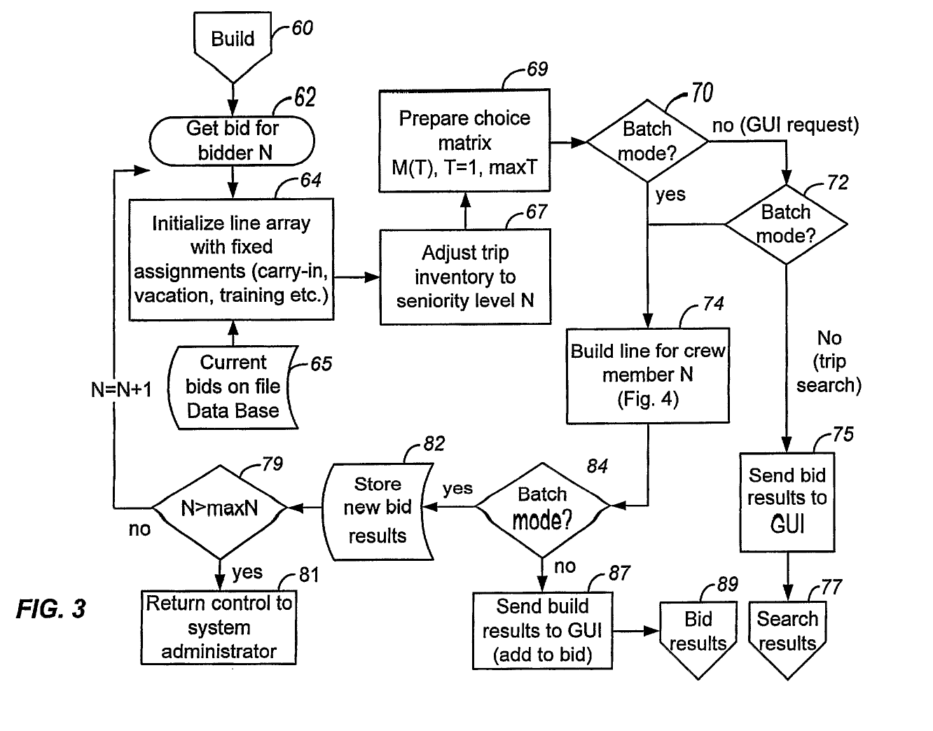

FIG. 3 illustrates the preferential bidding system (PBS) engine that drives the allocation of trips to crew members. The required steps of the operation are illustrated in FIG. 3, to satisfy the batch vs. query mode of the application. The computer upon which the software operates must be capable of returning in a reasonable time an optimized solution that can then be interactively modified to meet new bidding parameters at any seniority level. The extent of computational capability required will depend on the number of crewmembers and the desired speed of operation. Two separate modes of operation are preferred—a global solution solver (batch mode) and an interactive solution solver that based on the global solution at hand, can produce in a timely fashion alternatives submitted by crew members (query mode).

A distinctive benefit of the system is the separation of the allocation process into two separate functions—the rating of the trips and their assignment. In some of the prior art systems referred to above, both tasks are handled in a single process where the rating of a crew member's preference is done in conjunction with the building of the line. In those systems, each trip is given a numerical value defining the importance of that trip from which the assumed best allocation is produced. In such systems the crew member has no appreciation of this ‘objective’ rating and is often surprised by the resulting outcome. In the system of this invention, the crewmember sees the rating of his preferences and can reorder them as desired, as he is made aware of the consequences of his preferences.

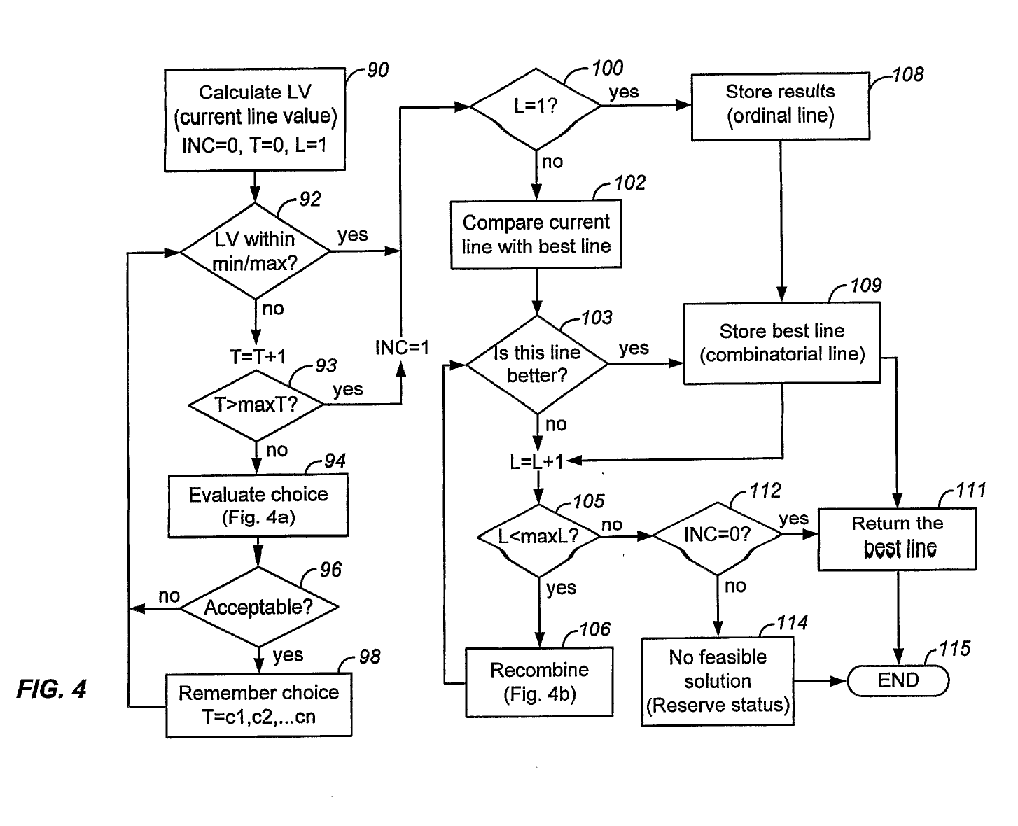

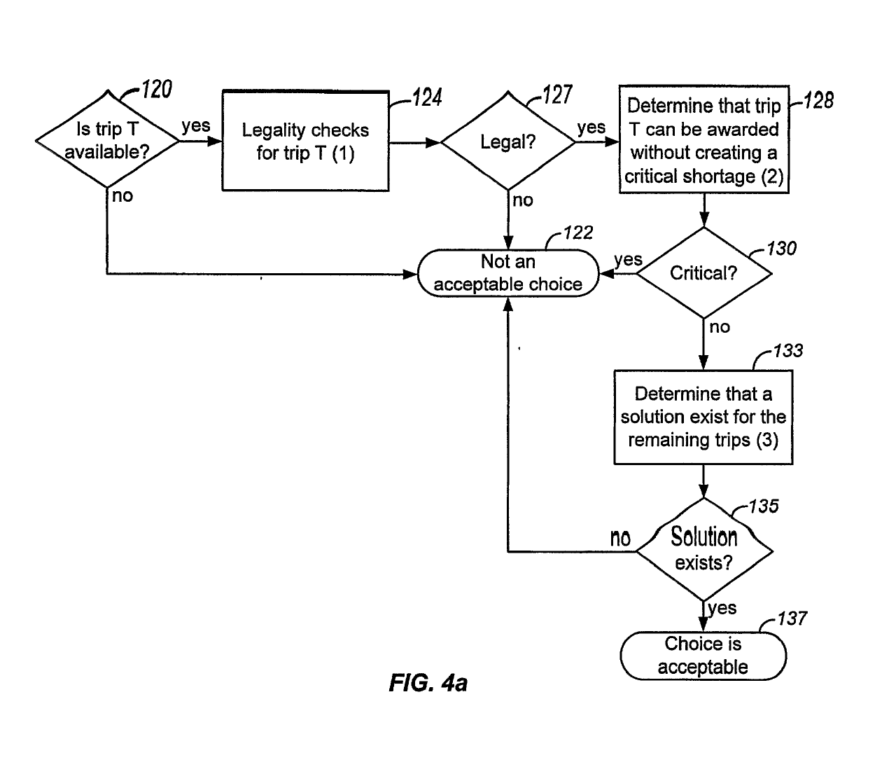

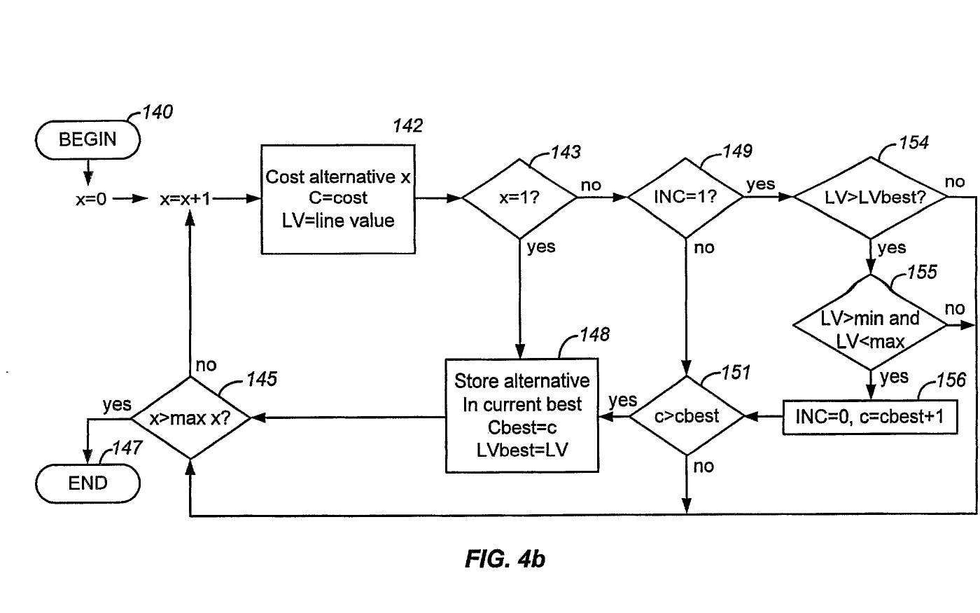

The operation of the system of FIG. 3 begins with a request to build 60 a particular schedule for a particular crew member. As shown at step 62, the first step is to receive a bid from the bidder. In response, at step 64 the line array or list of all existing schedule for that crewmember is initialized with fixed assignments such as existing trips, vacation time, training requirements, federal regulations, etc. This information is retrieved from the current bids on file in a database 65. At step 67 the trip inventory is adjusted based on the seniority level of the bidder. In this operation, flights that are already filled by crewmembers having higher seniority (or whatever metric is used for the system) are not available. The array of all available and legal trips are ordered as per bid instructions as described later below. The choice matrix 69 is prepared for each bid trip T, iterating from the first trip (1) to the maximum number of trips maxT. Depending on the origination of the build request and the need to produce a line or not, the program shifts to batch mode at step 70 and builds a line for the crewmember at step 74, otherwise when the only requirement is the generation of the matrix of choices (step 70+step 72) would lead to step 75 and 77 followed by step 226. the actual building operation is shown in more detail in FIG. 4.

After the line is built for crew member N the system moves to step 84, where the bid results are either permanently stored at step 82 (batch mode) or sent to the GUI at step 87. At step 87 the control is returned to the GUI application where bid results are displayed, as shown by steps 87 and 89 leading to step 226. On the other hand, if the system is in batch mode, then at step 79 control is returned to step 62 to service the next crewmember. Once the last crewmember is serviced, control returns to the system administrator at step 81 leading to step 24 with the condition ‘job ended’.

FIG. 4 illustrates the process of line building. The crewmember has the choice of selecting either of two line-building methods—ordinal or combinatorial. Ordinal is a method of line building that strictly follows the order in which the pairings were presented to the line builder (trip rating step 226). The crewmember has control over the order in which the trips are selected and then processed by the line builder. The process of ordering the trip is called “Trip Rating.” The trip rating phase is separate from the line building phase and is described later below. This system uses the ordering specified by the crewmember. Further the crewmember is immediately informed of the proposed disposition of his choices based on the inventory at hand

The combinatorial line building seeks to “optimize” the crewmember's satisfaction. The “optimization” is in minimizing how far down the list of trips (trip rating) the line builder has to go to find a legal combination of pairing choices. For example, the ordinal line may consist of trips ranked number 1, 3 and 25. However, a legal line could also have trips ranked number 2, 5 and 10. Such a line would be favored as the preferred combinatorial line. The choice of which logic the line builder should use in building the crewmember's line is determined by the crewmember.

The backup line is a combinatorial line built without using any of the trips that were awarded by the ordinal build. This is considered a “worst case scenario” akin to a lower boundary of satisfaction. If the crewmember is not happy with the backup line, then he would bid additional trips so the line builder will have other selections to work with should the preferred ones become unavailable. In other words the backup line gives the bidder an appreciation of the ‘depth’ of the bid, a new concept not found in any existing system.

The system provides disclosure of all pertinent line building constraints that a crew member needs to know prior to bidding. When the crewmember logs into the system, the crewmember will see information specific to his/her status such as carry-in and planned absences for the schedule period.

FIG. 4 is a flowchart illustrating the line builder operation. Beginning at step 90, the line value (total hours already assigned) is calculated. The trip number T is set to 0, the line L is set to 1, and a flag for whether the schedule is complete or incomplete is set to 0 (complete). The process then moves to step 92 where a determination is made as to whether the line value is within the minimum and maximum limits, i.e., the crewmember's schedule has at least as many hours as minimally required and no more than maximally permitted. If it does not, then the process then moves to step 93, and the first trip in the choice matrix is considered. It is important to note that in the choice matris M(t) t=1,tmax all of the available trips are include, M(t) provides the ordering and enumeration sequence to be followed by the line builder. M(t) is has shown to the crew member (step 228). The selected trip is evaluated as to its acceptability at step 94. The evaluation process is described in more detail in conjunction with FIG. 4a.

If the choice is acceptable, as determined at step 96, then the system stores the choice at step 98 and returns back to the beginning of the process for a determination of whether the now new line value is between the minimum and maximum. If the line value is within the minimum or maximum at step 92, or if the line is incomplete (t has reached its maximum value, i.e., all available trips have been evaluated and line is not within the desired min/max window), as shown by step 93, then the process moves to step 100. At step 100 the line is stored at step 108 if it is the first line (L=1) and remembered as the ‘ordinal line’, or if L>1 (it is not the first line) it is compared with the best line already of record at step 102. If the new line is better, as determined in step 103, then it is stored at step 109. If the new line is not better, then the line counter (L) is incremented, and provided that is not greater than MAXL a new is created at step 106, L indicates the number of different lines that have been built and is arbitrary (user supplied parameter), obviously response time is directly proportional to the value of MAX. The recombined process is described in detail in conjunction with FIG. 4b, and functions to determine which of the multiple proposed lines provides the highest satisfaction of the crew member's constraints. On the other hand, if at step 105 a determination is made that the line is equal to or greater than the maximum number of lines, then a check is made as to whether the line is incomplete. If it is incomplete, then flow moves to step 114, and a determination is made that there is no feasible solution, meaning that the crew member cannot change the line without violating one constraint or another imposed by the system. If the line is not incomplete at step 112, then the best line 111 is returned to the user, and the process ends at step 115. Note that the best line stored at step 108 (ordinal line) is also stored at step 109 as the first combinatorial line and is not necessarily the best choice, but often there is no better combinatorial line (step 103 always returns ‘no’) and the combinatorial choice and ordinal choice are the same.

FIG. 4a illustrates the evaluation process which is shown as block 94 in FIG. 4. The evaluation process begins with a check at step 120 as to whether a particular trip T is available (i.e., not awarded to a more senior crewmember). If it is not, the system returns an indication that the choice is not acceptable at step 122. If trip T is available, then legality checks are performed for that trip for the particular requestor, as shown by step 124. The legality checks include checking various company rules, federal regulations, or other aspects of the particular trip to assure that it is legal for that crew member to fly that trip in conjunction with other trips that he may have already been assigned to. For example, regulations may preclude a pilot from flying more than a certain number of hours during a certain calendar period, and the legality checks assure that those regulations are satisfied before allowing the trip to be tentatively assigned to that crew member. Assuming the legality checks are satisfied as shown at step 127, then a test is done at step 128 to determine whether the trip can be awarded without creating a critical shortage.

A critical shortage exists when at any given time there are more duties to be covered than there are crews available. If the assignment of the particular trip would create a critical shortage, as shown at step 130, the system returns that the choice is not an acceptable choice, as shown at step 122. Assuming that no critical shortage is created, then at step 133 determination is made as whether a solution exists for the remaining trips. At step 135, if a determination is made that a solution exists, then the choice is flagged as acceptable and so designated to the crew member at step 137. The determination of whether a solution exists for the trips remaining can use any appropriate algorithm (formal or heuristic) to determine the existence of a solution within the stipulated constraint system. Combinatorial Optimization, Papadimitirou and Steiglitz, Dover Publications, 1998, describes suitable algorithms.

FIG. 4b illustrates the recombined process in detail. This process was shown in block form as block 106 in FIG. 4. As shown in FIG. 4b, the process begins at step 140 with the initialization of a counter (x) that will determine the number of recombination that have been considered. The value x is then incremented by 1, and the process moves to step 142 and a new alternative is derived by substituting other choices to existing ones to which a cost function is calculated for the resulting line. The cost function associated with each selection represents a degree of satisfaction that was achieved with the particular assignment. In this case, higher costs are better so that if the cost of line 1 is greater than the cost of line 2, then the selection of line 1 is made. The cost function preferably is a weighted average of the trips in the line dictated by the order they appear in the matrix and/or the line make-up when overall line features (not trip dependent) have been specified. The exact nature of the cost function can vary from user to user and often driven by decisions made by the crewmembers as a group. The maximum number of recombination allowed (max x) is arbitrary and user supplied. After the cost function is calculated, in step 143 a test is made as to whether this is the first alternative being considered. If so, it is stored as the current best alternative at step 148. If it is not, then a test is made as to whether the line is complete at step 149. If it is incomplete (INC=1), then the process moves to step 154 where a determination is made as to whether the new line value is greater than the stored best line value (not cost). If step 155 is satisfied (the line is no longer incomplete) the cost is forced to be greater than the up to now best cost (c=cbest+1) thereby forcing its selection at step 151. When a line which started as incomplete is now complete INC is set to zero and the branch at step 149 will always be the ‘no’ alternative. All steps eventually lead to step 145 as to whether the number of alternatives exceeds the maximum number. If it does, the process ends at step 147. If it does not, then the process goes back to generate the next alternative and computes its cost at step 142. The process repeated until x reaches max x.

Bid entries are all implemented by a computer mouse point and click operation associated with menu driven choices. These choices reflect various characteristics associated with a trip, i.e. layover, length of trip, etc. They can be different for different crew member groups and are user defined. A typical bid consists of many successive criteria, punctuated by an add-to-bid operation which automatically triggers a line to be built based on whatever has been selected to date.

When the crewmember clicks on an ADD-TO-BID icon, the system generates his preferential line using the latest available inventory of trips and days off at his seniority rank and returns the results of the crewmember's bid. This process may be repeated as many times as the crewmember desires. The crewmember will be directly notified if any choices (trips and days off) made earlier are no longer available or have changed. Further, he will be informed of the certainty, or lack thereof, of his choices, as the bids of those of higher seniority or preference are gathered and processed.

The crewmember is allowed to bid a combination of choices that are not necessarily consistent or even possible to achieve. A bid for more days off than can be held is a valid bid or bidding trips that conflict with each other and/or with days off is valid as well.

When a bid request cannot be completely satisfied, for example, if the crewmember bids for the entire month off, the bid is automatically degraded according to the feasibility of building a line within the stipulated min/max window. The system does not allow the crewmember to enter an invalid bid, for example he/she cannot a bid for trips that do not exist, since all choices are menu driven based on the airline computer inventory of trips.

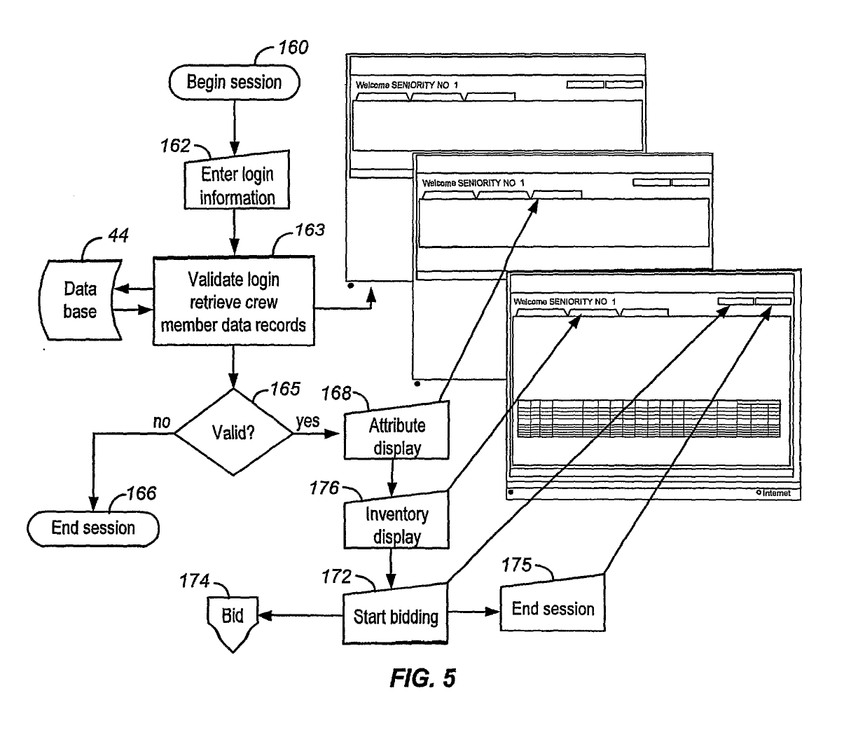

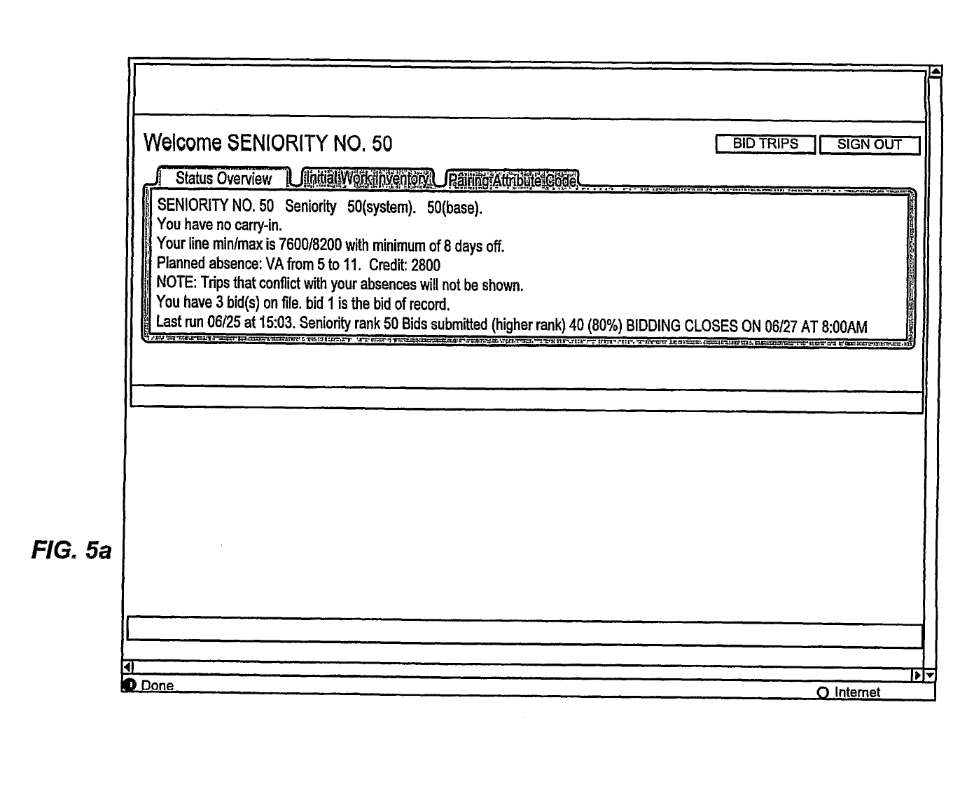

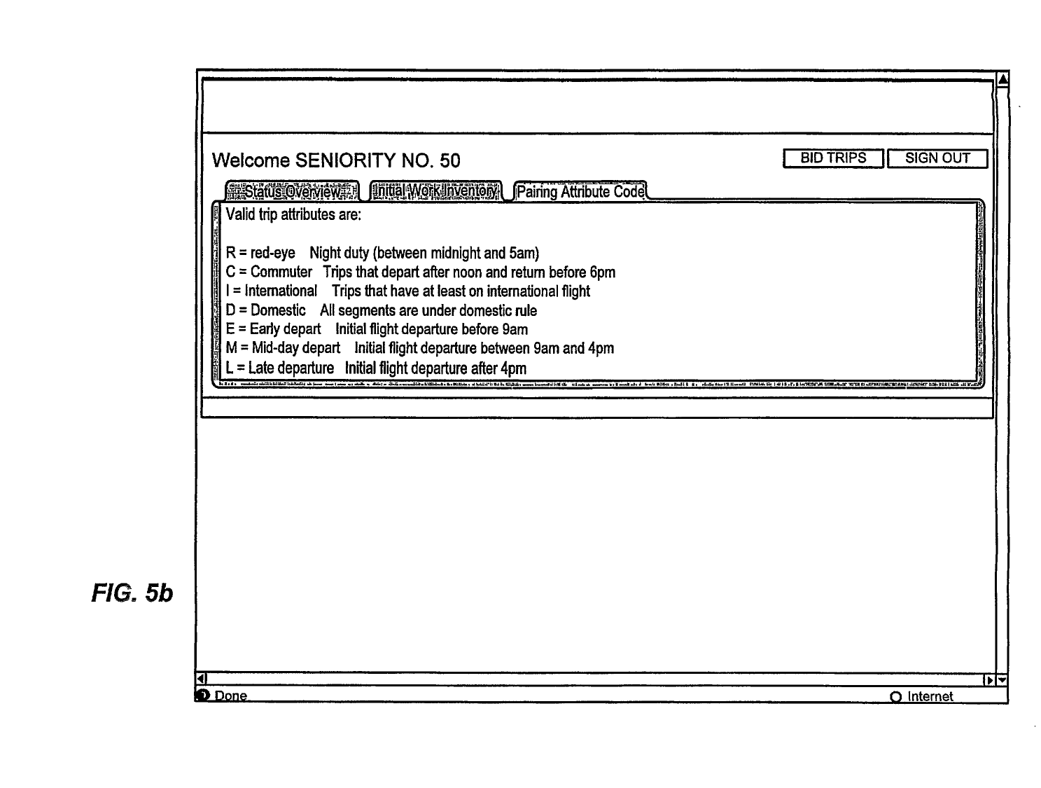

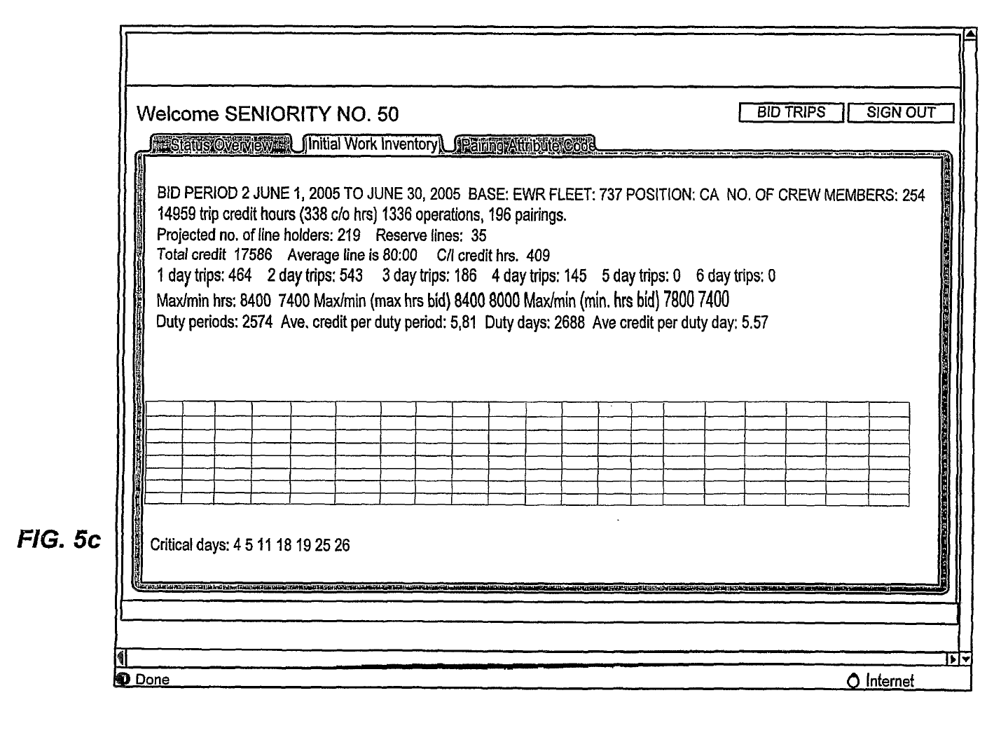

FIG. 5 is a flowchart which illustrates the interaction of a crew member with the bidding process, primarily to depict the user interface. FIGS. 5a, 5b, and 5c are expanded portions of FIG. 5 to illustrate the user interface in more detail. As shown in FIG. 5, the session begins with step 160. The crew member enters his login information at step 162. In response, the system validates the login and retrieves that crew member's data records. The figure illustrates the typical graphical user interface for those operations in the upper portion of FIG. 5. Assuming the login is validated and the records are appropriately retrieved, the system moves from step 165 to step 168 where the crewmember can review pertinent overall information. By clicking on a tab on the screen the crew member can display the attributes that have been associated with trips which are often used in bidding (step 169, FIG. 5b), or display the workload for the bid month (step171, FIG. 5c) including day by day requirements needed to cover the proposed trips, required reserve days and resulting available days off, a tabulations of all days off current51 bid crew member allowing an appreciation for the highly demanded days off. Then at step 172, by clicking on the ‘bid Trips’ icon the bidding process is initiated or the session can be ended by clicking on the “End Session” icon step 175.

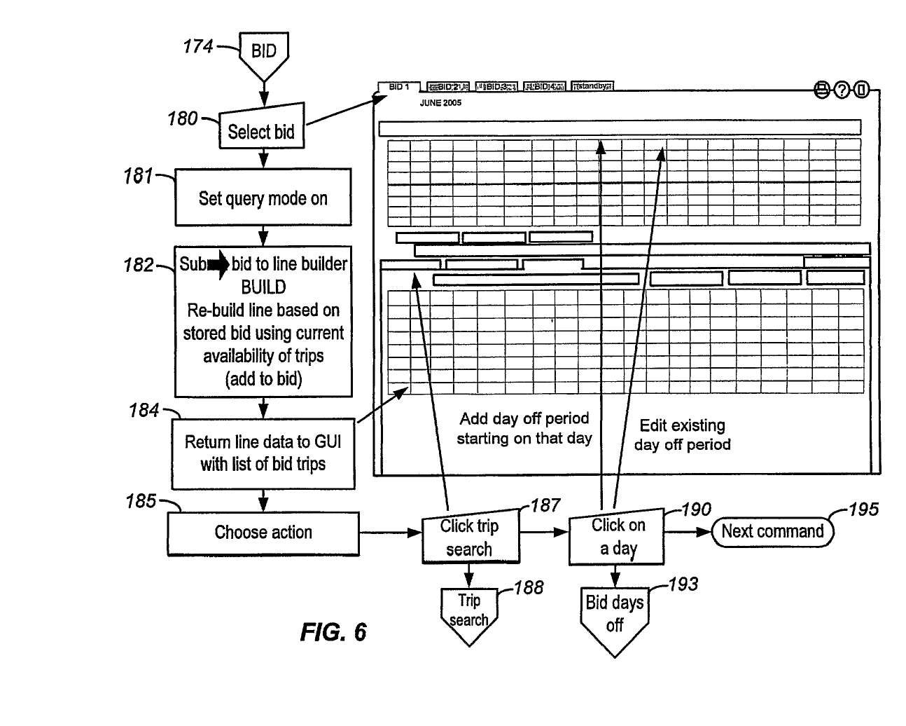

FIG. 6 illustrates the bidding process 174 from FIG. 5. As shown there, the crew member selects a tab on the display to enter the first bid. The query mode is then set to “on” at step 181 and the bid is submitted to the line building software described in conjunction with FIG. 4. In response the software builds the potential lines and displays them on the screen as shown by step 184. The lines are built on the basis of the bid using the current availability of trips. At step 185 the crew member chooses the action to be performed, for example by choosing to search for a particular trip 87 or a particular day for a trip 190, or by bidding days off at step 193. If a particular trip is sought, then a trip search is performed as shown by step 188.

The system generates an audit trail that is part of the Bid Results display so that a crew member can identify the reason why a certain trip was not awarded. When the bid results are displayed, the trips are listed in the order they were rated. The trips highlighted in one color are the trips awarded to the crewmember. Next to every non-awarded trip is a three letter code identifying the reason that particular trip was not awarded to the individual. Examples of these codes are OVL (overlap), MAX (exceeds maximum credit hours), etc.

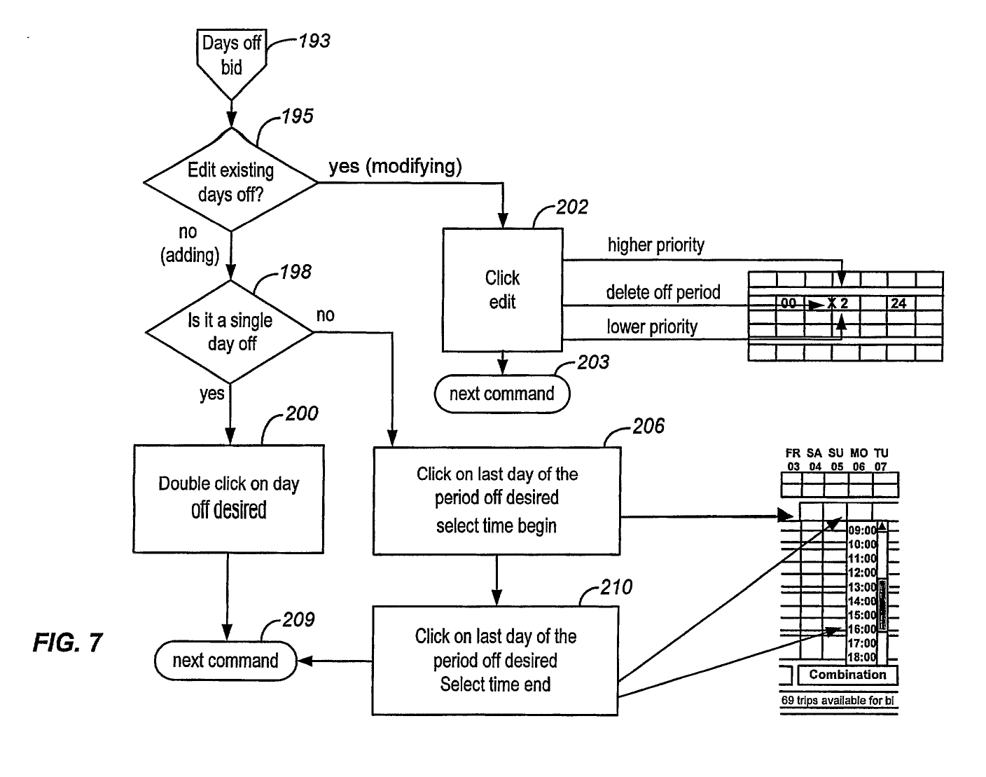

FIG. 7 is a flowchart illustrating the bidding process for days off as shown by block 193 in FIG. 6. As shown in FIG. 7, the crewmember can add days off period or edit existing ones by clicking on the desired day. If the day clicked already has a day off period defined, the edit function 202 is invoked and the crew member can adjust the particular days off as shown by the portion of the GUT to the right of block 202. Otherwise he clicked a day off that was blank and he can define a single day off by clicking on the day again (step 198 yes) or periods covering more than one day (step 198 no) choosing the time of day he wishes the day off to begin/end and dragging the mouse pointer to the day the off periods ends and clicking on the time of day he wishes the day to end/begin (step 206 and 210). The day off period can defined starting with the end day and going to the begin day or vice versa to allow the crew member to indicate a relative importance of the days off, the most import being the one first clicked. Thus if a period of 10 days off is defined say from day 15 to day 5, the line builder understands that infringement if necessary should be starting with day 5 and not 15. The system then transitions back for a next command at step 203.

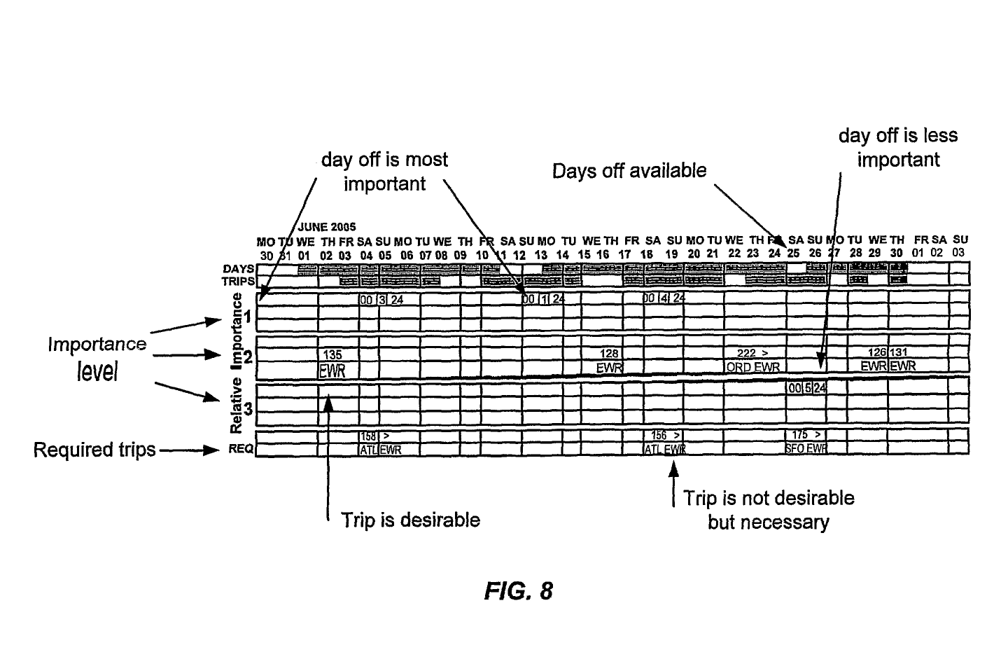

FIG. 8 explains the components of the line display once the line has been built to specification reflecting the relative importance associated with the demand, so that for example a day off specified at importance level 2 may be overridden by a trip on same days at level 1 (more important). There are three possible levels of distinction which allows the crew member to partition his bid ‘the most important’, ‘the important and ‘the least important’. This stratification unique to the invention allows the crewmember to quickly grasp and understand the results given. If a trip which has not been bid for or is required due to a mandatory condition it appear on the REQ line.

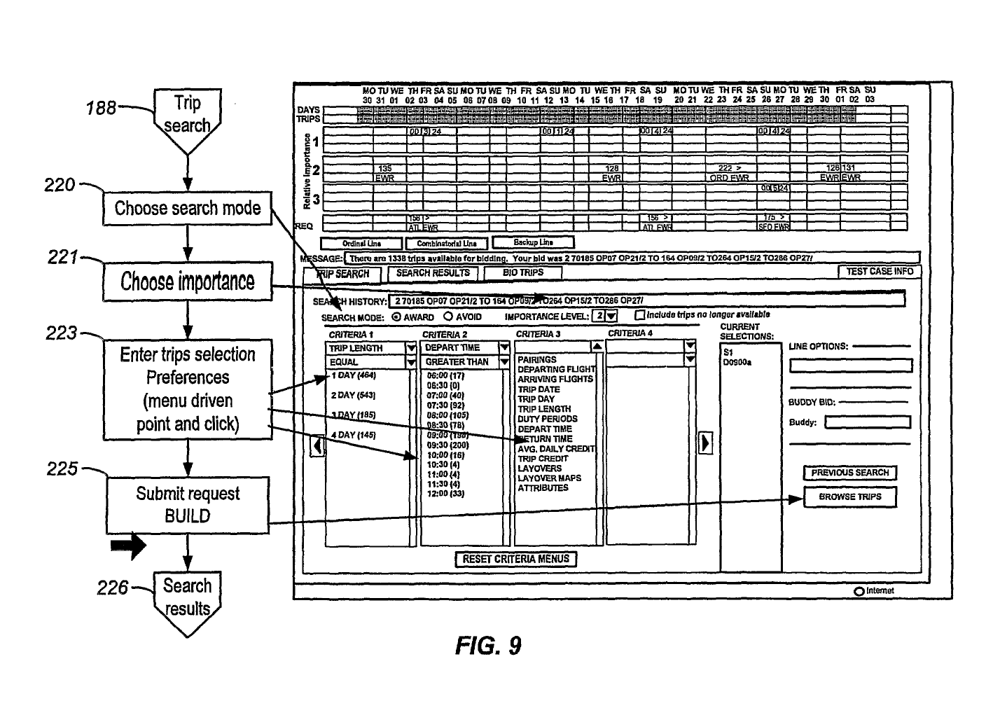

FIG. 9 illustrates the flow chart for the trip search as shown by block 188 in FIG. 6. The process begins with the crew member selecting a search mode of either avoiding trips or avoiding particular days for trips. At step 221 the importance of particular goals is specified typically by a numeric pulldown menu. Then at step 223 trips are selected by various preferences of length, departure time, and other criteria using a menu. Once the crew member is satisfied with the criteria, then at step 225 a request is made to build a list of trips which satisfy the particular criteria as closely as possible. The search results are then presented at step 226.

The client system is provided with an identifier that identifies the crewmember. The primary crewmember bid entry screen preferably displays the bid results and three tabs. These tabs display a Search Trips window (preference selection), a Search Results window (available trips based on these preferences) and a Bid Results window (tentatively awarded trips). In response to the indicated action being performed, the client system sends to the server system the provided identifier and the requested action. The server system uses the identifier to identify additional information that may be required and then executes the desired action. The server system receives and stores the information for crewmembers so that the server can generate the line awards. The server system stores the received additional information in association with an identifier of the crewmember.

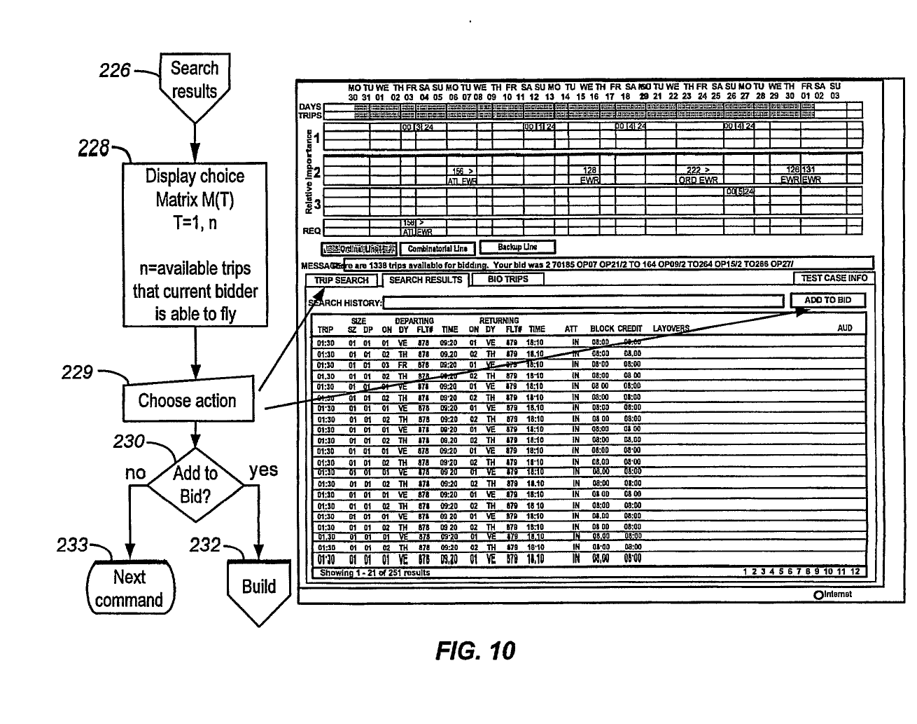

FIG. 10 illustrates the flow chart for the bidding process once the selected trips satisfying the desired criteria are presented to the crew member. At step 228 the results of the trip search are displayed, for example, as depicted on the right hand side of the flow chart. All of the trips are listed which the current bidder is eligible to fly based on avoiding conflicts with already assigned trips and satisfying the general preferences entered by the crew member. By highlighting the various trips and then choosing whether to add them to the bid at step 230, the system adds them to the crew member's bid. If they are added then the build step 232 is performed. If they are not the system waits for the next command at step 233.

FIG. 11 is a diagram illustrating the actual bidding process 174 as first shown in FIG. 5 in block form. The display first depicts the results of the various preferences shown by the crew member in the earlier screen, enabling the crew member to highlight the selected trips at step 242. The trips may then be cleared or saved or bid as shown in step 243, and then the system waits for the next action at step 244.

The preceding has been a description of the preferred embodiments. The scope of the invention is set forth by the appended claims.

What is claimed is:

1. A computer implemented method of assigning tasks from a large number of tasks to individuals, the individuals having different preferences for the tasks and different priorities for being assigned the tasks, the method comprising:
displaying information to one individual identifying available tasks;
retrieving information previously stored for the individual, including previously assigned tasks;
receiving from that individual a request for scheduling of tasks and information regarding that individual's preferences among the available tasks;
calculating a schedule for the tasks for that individual based on the preference information for the individual which schedule attempts to satisfy the individual's preferences;
repeating the steps of receiving and calculating to prepare a schedule accepted by the individual; and
presenting the schedule to the individual.

2. A method as in claim 1 wherein the computer calculates the schedule for the individual and in doing so relies upon a set of schedules from other individuals who were previously assigned schedules based upon their preferences.

3. A method as in claim 2 wherein following the step of presenting the schedule to the individual, if the schedule is accepted by the individual, a step is performed of recalculating the schedules of the other individuals based on the accepted schedule of the individual.

4. A method as in claim 1 wherein the tasks comprise airline flights and the individuals comprise crewmembers.

5. A method as in claim 4 wherein the step of displaying information comprises not displaying flights on which all crewmembers are of greater seniority than the individual.

6. A method as in claim 1 wherein the step of calculating a schedule comprises building a schedule for that individual which satisfies previously specifies minimum and maximum constraints.

7. A method as in claim 1 wherein the individual may enter multiple requests for scheduling of tasks, and the step of calculating a schedule calculates schedules for each of the multiple requests, compares them with each other, and selects one such schedule as most closely satisfying the requests.

8. A method as in claim 1 wherein the step of receiving further comprises accepting information from an internet browser.

9. A method as in claim 8 wherein the preferences include days off from work.

10. A system for interactively generating a schedule for a crewmember comprising:
a client for receiving information from a crewmember and a display for displaying trip inventories;
a storage for storing information about trip inventories and crewmember status; and
a server coupled to the client for receiving preference information therefrom and coupled to the storage for retrieving trip information therefrom, whereby the server displays trip information, and in response to preference information entered into the client by the crewmember, the server calculates a schedule for the crewmember in accordance with the preference information, and the crewmember can select to add to the crewmembers schedule in accordance with the calculated schedule.

11. The system of claim 10 wherein the client interfaces to the server using a browser.

12. A system as in claim 10 wherein:
the storage stores information about a plurality of crewmembers, and the server satisfies the preferences of crewmembers having a higher status over those of crewmembers having a lower status; and
the server recalculates the previously determined schedules of crewmembers of lower status after receiving preference information from crewmembers of higher status.

13. A method for preferential bidding using a client system, the method comprising:
displaying information to identify available trips, available days off, working parameters, and reserve requirements for a crewmember group; and
receiving preferences from a crewmember;
calculating a schedule for the crewmember to provide a degree of satisfaction of the preferences;
accepting further preferences from the crewmember;
recalculating the schedule of the crewmember in accordance with the further preferences;
receiving an acceptance of the recalculated schedule from the crewmember;
recalculating the schedules of other crewmembers which schedules are changed as a result of the acceptance; and
informing the other crewmembers of the recalculated schedules.

14. A method as in claim 13 wherein a predetermined period before a trip, a step is performed of freezing the schedules of the crewmembers on that trip and notifying them of the final schedule.
